(19) United States
(12) Patent Application Publication
(10) Pub. No.: US 2025/0121896 A1
(43) Pub. Date: Apr. 17, 2025

(54) ROLLED TRACK LINK

(71) Applicant: Caterpillar Inc., Peoria, IL (US)

(72) Inventors: Eric J. JOHANNSEN, Washington, IL (US); Chad M. ARNOLD, Peoria, IL (US); David J. HAKES, Princeville, IL (US); Seiji Iijima, Akashi-shi (JP); Yu Matsumoto, Akashi-shi (JP); Yasuo Yamashita, Akashi-shi (JP)

(73) Assignee: Caterpillar Inc., Peoria, IL (US)

(21) Appl. No.: 18/484,920

(22) Filed: Oct. 11, 2023

(51) Int. Cl. B62D 55/21; B21B 1/08; B23P 23/02

(52) U.S. Cl. CPC B62D 55/21; B21B 1/08; B23P 23/02; B23P 2700/50

(57) ABSTRACT

A rolled track link may comprise a central portion, a front portion, on a front side of the central portion, having a front portion planar upper surface and a pin bore, and a back portion, on a back side of the central portion, having a back portion planar upper surface that is offset from the front portion planar upper surface by a perpendicular distance along a height of the track link, and having a bushing bore. At each point along a length of the track link, a thickness of the track link is uniform along a width of the track link, other than at holes, including the pin bore and the bushing bore.

### TECHNICAL FIELD

The present disclosure relates generally to a track link for a track assembly of a machine, and, more particularly, to a track link having a front portion and a back portion, a plane defining the front portion being offset from a plane defining the back portion by a perpendicular distance.

### BACKGROUND

Track assemblies of track type machines, such as dozers, excavators, and skid-steer loaders, include a loop of link assemblies that support a loop of track shoes as the loop rotates around a sprocket and an idler assembly. Each link assembly includes a pair of track links mounted to a bushing, at a front end, and a pin, at a back end. Each link assembly is pivotably connected to adjacent link assemblies, in the loop, using bushings and pins. Track shoes are attached to each link assembly using bolts and nuts. Typically, track links are forged into relatively complex three-dimensional shapes, or they are formed by multiple pieces that are welded together. In either case, manufacturing track links can be costly due to the complexity of the final product, and the time and material required to form the final product.

To provide a track link having a relatively strong coupling to a track shoe, European Patent No. 0921057 B1 (the '057 patent) provides for a track link that is formed to have a flange, integrally formed with the link. The flange is bent to be at a right angle relative to an intermediate portion. Forming the track link of the '057 patent thus requires bending of a portion of the track link during a manufacturing process, to form the flange at the right angle to the intermediate portion. The track link of the '057 patent thus has a relatively complex three-dimensional shape and requires additional steps in the process of manufacturing same.

The track link, and related track link assembly and method of manufacture, of the present disclosure may solve one or more of the problems set forth above and/or other problems in the art. The scope of the current disclosure, however, is defined by the attached claims, and not by the ability to solve any specific problem.

### SUMMARY

In one aspect of the present disclosure, a rolled track link may comprise a central portion; a front portion, on a front side of the central portion, having a front portion planar upper surface and a pin bore; and a back portion, on a back side of the central portion, having a back portion planar upper surface that is offset from the front portion planar upper surface by a perpendicular distance along a height of the track link, and having a bushing bore. At each point along a length of the track link, a thickness of the track link is uniform along a width of the track link, other than at holes, including the pin bore and the bushing bore.

In another aspect, a track link formed by rolling may consist of a central portion; a front portion, on a front side of the central portion, having a front portion planar upper surface and a pin bore; and a back portion, on a back side of the central portion, having a back portion planar upper surface that is offset from the front portion planar upper surface by a perpendicular distance along a height of the track link, and having a bushing bore.

In still another aspect, a method of manufacturing one or more track links may comprise rolling a sheet of a material lengthwise to form a cross-sectional shape having a central portion, a front portion on a front side of the central portion that is defined by a front portion plane, and a back portion on a back side of the central portion that is defined by a back portion plane that is offset from the front portion plane by a perpendicular distance along a height of the sheet of material; cutting the rolled sheet of material at a predetermined width, into the one or more track links each having a uniform thickness along the width; and forming a pin bore through the front portion and a bushing bore through the back portion of each track link.

### BRIEF DESCRIPTION OF THE DRAWINGS

FIG. 1 shows a schematic side view of a dozer, as an example of a track type machine, having track link assemblies including a track link, in accordance with the present disclosure.

FIG. 2 shows a schematic isometric view of a track link according to a first embodiment, in accordance with the present disclosure.

FIG. 3 shows a schematic isometric view of a track link according to a second embodiment, in accordance with the present disclosure.

FIG. 4 shows a partially-exploded schematic view of track link assemblies, including the track link of the second embodiment shown in FIG. 3, in accordance with the present disclosure.

FIG. 5 shows a flow chart of a method of manufacturing a track link, in accordance with the present disclosure.

FIGS. 6A and 6B are schematic views of sheets of rolled material, in accordance with the method shown in FIG. 5.

FIGS. 7A and 7B are schematic views of cut track links, in accordance with the method shown in FIG. 5.

FIGS. 8A and 8B are schematic views of trimmed track links in accordance with the method shown in FIG. 5.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value.

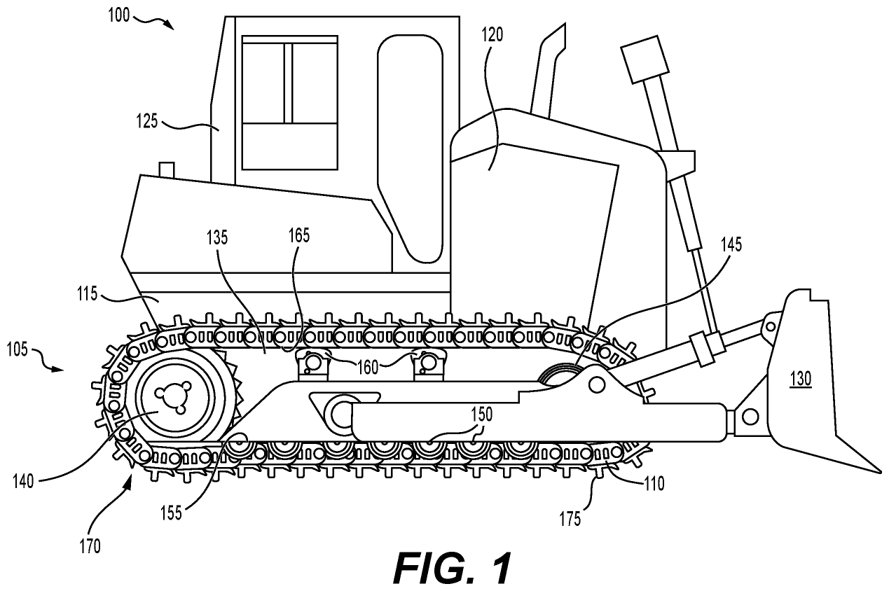

FIG. 1 shows a schematic side view of a track type machine 100 having a track assembly 105 including track links 110 in accordance with the present disclosure. The machine 100 includes a machine frame 115, supporting an engine 120, an operator station 125, and a work tool or implement 130. The machine 100 also includes a track support frame 135, provided as part of the undercarriage of the machine frame 115. The track support frame 135 supports the track assembly 105, the work tool 130, a sprocket 140, and an idler assembly 145. The track assembly 105 includes lower track support assemblies 150, provided on a lower surface 155 of the track support frame 135, and upper track support assemblies 160, provided on an upper surface 165 of the track support frame 135. In addition, the track assembly 105 includes a loop of track link assemblies 170, in a loop extending around the lower track support assemblies 150 and the upper track support assemblies 160. Each track link assembly 170 includes a pair of track links 110, a pin 285, and a bushing 240, as discussed in more detail below. The track assembly 105 further includes track shoes 175, connected to the track link assemblies 170, in a loop around the loop of track link assemblies 170. During operation, the engine 120 may generate a power output directed through the sprocket 140, to move the track link assemblies 170 and the track shoes 175, to propel the machine 100 forwards or backwards.

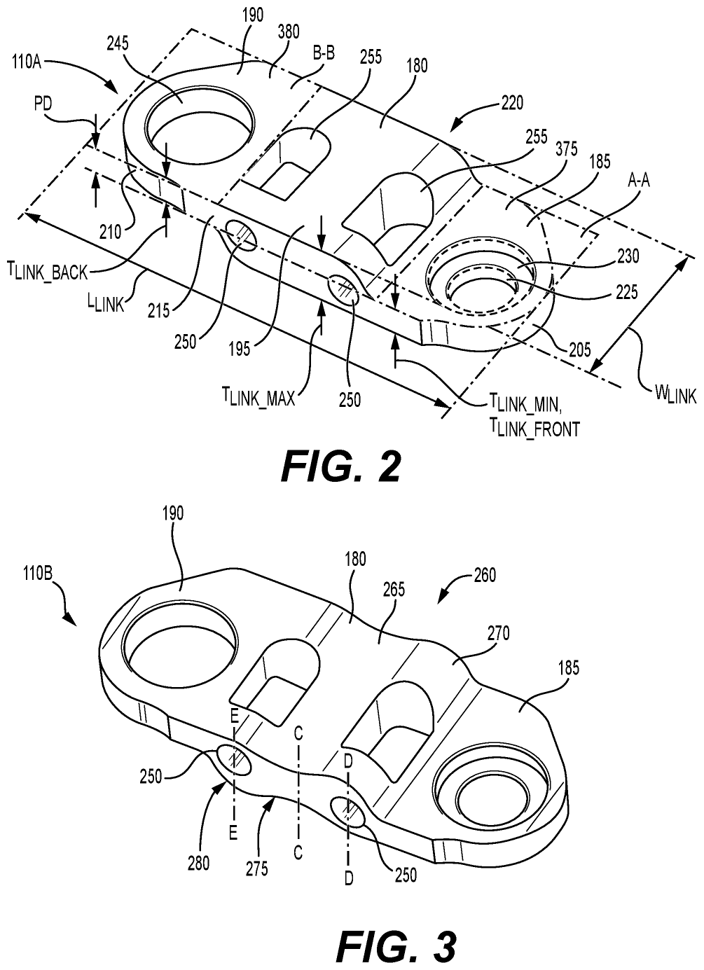

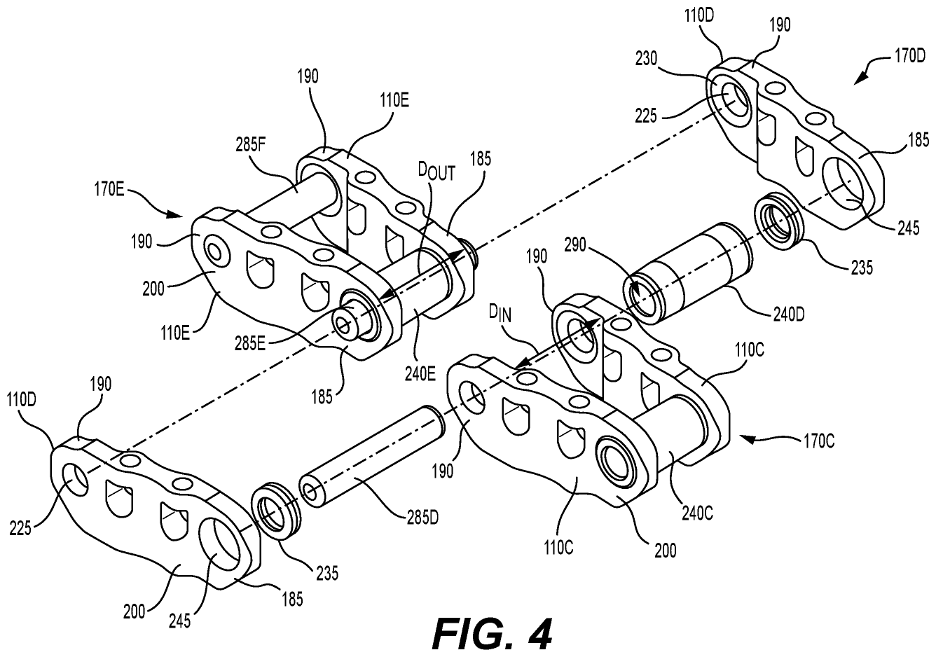

FIG. 2 shows a schematic isometric view of a track link 110A according to one embodiment. The track link 110A includes a central portion 180, a front portion 185, and a back portion 190. The track link 110A may include only the central portion 180, the front portion 185, and the back portion 190; that is, the track link 110 may not have any flanges or protrusions extending therefrom. The front portion 185 is defined by a front portion plane A-A, shown on an upper surface 375 of the front portion 185, and the back portion 190 is defined by a back portion plane B-B, shown on the upper surface 380 of the back portion 190. The upper surface 375 of the front portion 185 and the upper surface 380 of the back portion 190 may be planar. In addition, each of the front portion 185 and the back portion 190 has a lower surface (not shown), opposite to the upper surfaces thereof, and the lowers surfaces may also be planar. The front portion plane A-A and the back portion plane B-B may be offset from each other by a perpendicular distance PD, along a height or thickness of the track link 110A, in a range of about 0.5 mm to about 2.5 mm. In particular, for example, perpendicular distance PD may be about 1.5 mm. The track link 110A has an inner surface 195, an outer surface 200 opposite to the inner surface 195 (shown in FIG. 4), a front surface 205, a back surface 210, an upper side surface 215, and a lower side surface 220 opposite to the upper side surface 215. The upper side surface 215 of each track link 110A is configured to support and to be connect to a track shoe 175, and thus constitutes a bolted joint abutment surface, and the lower side surface 220 is configured to contact a track roller flange (not shown) to constrain lateral movement of the track link assemblies 170. The track link 110A may have a length L_{LINK}, a width W_{LINK}, a maximum thickness T_{LINK_MAX}, and a minimum thickness T_{LINK_MIN}, as shown in FIG. 2. The front portion 185 may also have a front portion thickness T_{LINK_FRONT} and the back portion 190 may have a back portion thickness T_{LINK_BACK}, as shown in FIG. 2. T_{LINK_FRONT} and T_{LINK_BACK} may be the same values or they may be different values. Further, one or both of T_{LINK_FRONT} and T_{LINK_BACK} may be the same as T_{LINK_MIN}.

The front portion 185 may include a pin bore 225 and a counter bore 230 near the inner surface 195 of the track link 110A and coinciding with the pin bore 225. The counter bore 230 may be configured to receive a seal 235 (shown in FIG. 4) and/or a bushing 240 (shown in FIG. 4) therein. The back portion 190 may include a bushing bore 245. Edges of the pin bore 225, the counter bore 230, and/or the bushing bore 245 may be chamfered. The chamfered edges may be rounded. Chamfering the edges may provide for smoother assembly and handling of the track links 110. The track link 110A may also include at least one bolt hole 250, extending through the central portion 180 in a direction that is perpendicular to that of the pin bore 225 in the front portion 185 and the bushing bore 245 in the back portion 190. That is, the bolt hole 250 extends into the upper side surface 215 of the track link 110, the upper side surface 215 being a surface that supports the track shoes 175. In the embodiment shown in FIG. 2, for example, the track link 110A includes two bolt holes 250. The bolt holes 250 are configured to receive bolts and nuts (not shown) for connecting a track shoe 175 to the track link 110. The track link 110A may also include a window 255, corresponding to each bolt hole 250. The window 255 may extend through the central portion 180, in a direction that is perpendicular to the direction of the bolt holes 250, such that the window 255 intersects the corresponding bolt hole 250.

FIG. 3 shows a schematic isometric view of a track link 110B according to an alternative embodiment. The track link 110B shown in FIG. 3 differs from the track link 110A shown in FIG. 2 in that the central portion 180 further includes one or more curved surfaces 260. In particular, for example, the central portion has an inner concave curved surface 265, an inner convex curved surface 270, an outer concave curved surface 275, and an outer convex curved surface 280. Put another way, the central portion 180 may have a curved surface 260 that is a concave curve, and a concave surface 260 that is a convex curve. The inner concave curved surface 265 and the outer concave curved surface 275 may align with each other along a vertical axis C-C, as shown in FIG. 3. And the inner convex curved surface 270 may align with a bolt hole 250, and the outer convex curved surface 280 may align with another bolt hole 250, along vertical axes D-D and E-E, respectively, as shown in FIG. 3. A thickness of the central portion may vary, by virtue of the curved surfaces 270. The track links 110A and 110B shown in FIGS. 2 and 3 may be formed of steel, for example, and more specifically, alloyed steel, induction heat treated steel, or furnace heat treated steel. And, as discussed in more detail below, the track links 110A and 110B shown in FIGS. 2 and 3 may be formed by rolling, that is, they may be formed of rolled material, such as rolled steel.

FIG. 4 shows a partially-exploded schematic view of three track link assemblies 170, each including two track links 110, corresponding to the track link 110B shown in FIG. 3. In particular, FIG. 4 shows track link assembly 170C, track link assembly 170D (in an exploded view), and track link assembly 170E, as an example of three adjacent track link assemblies 170 in a loop. Each track link assembly 170C, 170D, and 170E includes two track links 110, a bushing 240, a pin 285, and seals 235 provided around circumferential surfaces of ends of the pins 285. The bushings 240, pins 285, and seals 235 provide for pivot joints between pairs of track links 110. When assembled to form a loop of track link assemblies 170, the front portions 185 of track links 110D are positioned between, or inside of, the back portions 190 of track links 110C, and the front portions 185 of track links 110E are positioned between, or inside of, the back portions 190 of track links 110D. That is, by virtue of the cross-sectional shapes of the track links 110, a distance Dour between outward facing surfaces of front portions 185 of track links 110E is less than a distance DIN between inward facing surfaces of back portions 190 of track links 110C, so that the front portions 185 of track links 110E nest within the back portions 190 of track links 110D. This same relationship applies for the outward facing surfaces of front portions 185 of track links 110D to inward facing surfaces of back portions 190 of track links 110C. In FIG. 4, DOUT is shown with respect to track links 110E and DIN is shown with respect to track links 110C, in light of the partially-exploded view.

The bushing 240C extends through, or is inserted into, the bushing bores 245 in the front portions 185 of track links 110C. The pin 285D is configured to extend through, or is inserted into, the pin bores 225 in the back portions 190 of track links 110C, and through a central through-hole 290 of the bushing 240D, and the bushing 240D is configured to be positioned between the back portions 190 of track links 110C, with ends of the bushing 240D sitting within the counter bores 230 in the back portions 190 of track links 110C. Similarly, the bushing 240D is configured to extend through the bushing bores 245 in the front portions 185 of track links 110D. The pin 285E is configured to extend through the pin bores 225 in the back portions 190 of track links 110D, and the bushing 240D is configured to be positioned between the back portions 190 of the track links 110D, with the ends of the bushing 240E sitting within the counter bores 230 in the back portions 190 of track links 110D. FIG. 4 also shows a pin 285F of still another track link assembly (not shown), the pin 285F being positioned within the pin bores 225 in the back portions 190 of track links 110E. The pins 285 and bushings 240 allow for the pairs of track links 110 to be rotatably connected to track links 110 of adjacent track link assemblies 170, so that a plurality of track link assemblies 170 form a loop.

### INDUSTRIAL APPLICABILITY

The track links 110, and the related track link assemblies 170 and method of manufacture, in accordance with the present disclosure, can be used in track type machines 100, such as dozers, excavators, and skid-steer loaders. Specifically, track link assemblies 170 and track links 110, in accordance with the present disclosure, can be used to form a loop of track link assemblies 170 that support a loop of track shoes 175, and, as the loop rotates around a sprocket 140 and an idler assembly 145, the track shoes 175 engage with a surface (terrain), to move the machine 100 forwards or backwards.

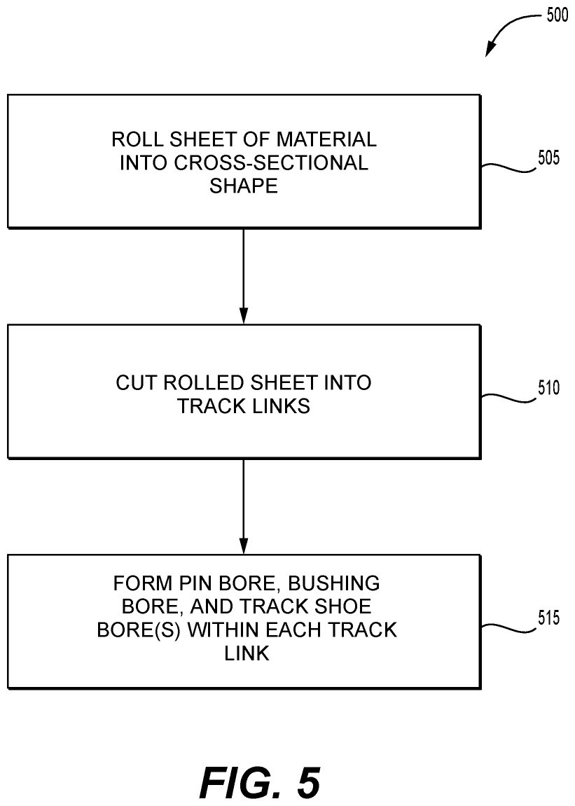

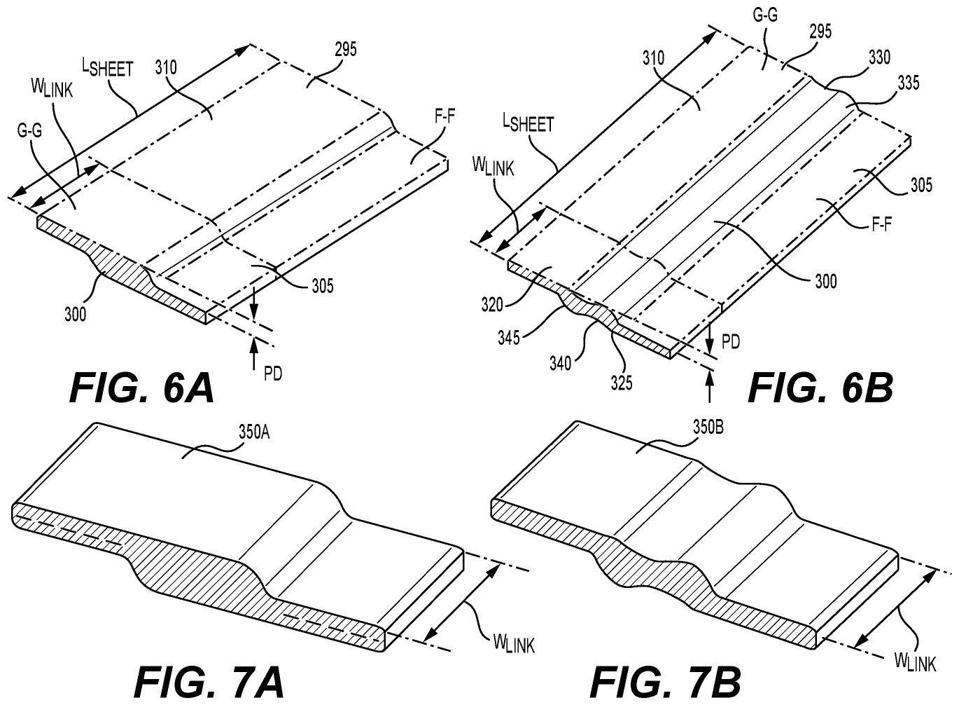

FIG. 5 shows a flow chart of a method 500 of manufacturing a track link 110, in accordance with the present disclosure. The method 500 may include a step 505 of rolling a sheet 295 of material lengthwise, to form a cross-sectional shape. Rolling the sheet 295 of material may include hot rolling or cold rolling the sheet 295 of material. As an example, hot rolling may be used in step 505, based on the section thickness, the material displacement (flow) required, the finished part grain structure, and residual stresses. More specifically, a direction of the flow and grain structure would be along a length of the link, by rolling a long bar in said direction. Rolling the sheet 295 of material provides for a resulting rolled sheet 295 having a uniform thickness along a length of the rolled sheet 295. The sheet 295 of material may be a length of the material, and may have an initial, uniform thickness. FIG. 6A shows the rolled sheet 295 of material used to form the track link 110A of the embodiment shown in FIG. 2, and FIG. 6B shows the rolled sheet 295 of material used to form the track link 110B of the embodiment shown in FIG. 3. The cross-sectional shape includes a center 300, a front end 305 on a front side of the center 300 that is defined by a front end plane F-F, and a back end 310 on a back side of the center 300 that is defined by a back end plane G-G. In each of the embodiments shown in FIGS. 6A and 6B, the front end plane F-F is offset from the back end plane G-G by the perpendicular distance PD. Although the perpendicular distance PD is shown relative to the planes F-F and G-G on an upper surfaces of the front end 305 and the back end 310 of the rolled sheet 295, the perpendicular distance PD may also be defined relative to planes on lower surfaces of the front end 305 and the back end 310. The perpendicular distance PD may also be defined relative to planes on upper surfaces of the front end 305 and the back end 310. The perpendicular distance PD may be in a range of 0.5 mm to about 2.5 mm, as noted above. And, as an example, the perpendicular distance may be about 1.5 mm. In addition, the cross-sectional shape of the rolled sheet 295 of material in each of FIGS. 6A and 6B is constant, along a length L_{SHEET} of the rolled sheet 295 of material.

In the embodiment depicted in FIG. 6B, the step of rolling the sheet 295 of material may include forming at least one curved surface 315 on the center of the sheet 295 of material. In particular, an upper surface 320 and a lower surface 325 of the sheet 295 of material may be rolled to include an upper concave curved surface 330, an upper convex curved surface 335, a lower concave curved surface 340, and a lower convex curved surface 345, as shown in FIG. 6B. That is, the at least one curved surface 315 may include a concave curve.

The method 500 may also include a step 510 of cutting the rolled sheet 295 of material into a plurality of functional track links 350. The functional track links 350 may be cut from the rolled sheet 295 of material to a predetermined width W_{LINK}. FIGS. 7A and 7B show the functional track links 350A and 350B cut from the sheet 295 of material to the predetermined width W_{LINK}. FIG. 7A shows the functional track link 350A, corresponding to the track link 110A shown in FIG. 2, and FIG. 7B shows the functional track link 350B corresponding to the track link 110B shown in FIG. 3. The functional track links 350A and 350B each have a uniform thickness along the width W_{LINK}. That is, at any given point along a length L_{LINK} of the track links 350A and 350B, a thickness along the width of that point is uniform, other than at holes, including the pin bore 225 and the bushing bore 245. Cutting the functional track links 350 may be done using a laser or a torch, using a shearing punch that is either hot or cold, or using a drill or a mill.

The method 500 may also include a step 515 of forming a pin bore 225, a bushing bore 245, and track shoe bore(s) within each functional track link 350. The pin bore 225 and the bushing bore 245 may be formed by drilling or using a laser or torch. The pin bore 225 is formed in the front portion 185 of each functional track link 350, and the bushing bore 245 is formed in the back portion 190 of each functional track link 350. The track shoe bore(s) include one or more bolt holes 250 within the central portion 180 of each track link 110. The bolt holes 250 may be formed by drilling or using a laser or torch, using a shearing punch that is hot or cold, or using a drill or a mill. In embodiments where windows 255 are not included in the track links 110, forming the bolt holes 250 may include drilling and tapping the bolt holes. And, in an embodiment in which windows 255 are included in the track links 110, the method 500 may include a step of forming the window 255 for each bolt hole 250, the window 255 extending through the central portion 180 of each track link 110, perpendicular to and intersecting the corresponding bolt hole 250. The window 255 may be formed by drilling or by a laser or a torch. The track link 110A shown in FIG. 2 corresponds to a track link formed in accordance with the method 500 and as described and shown with respect to FIGS. 6A and 7A, and the track link 110B shown in FIG. 3 corresponds to a track link formed in accordance with the method 500 and as described and shown with respect to FIGS. 6B and 7B.

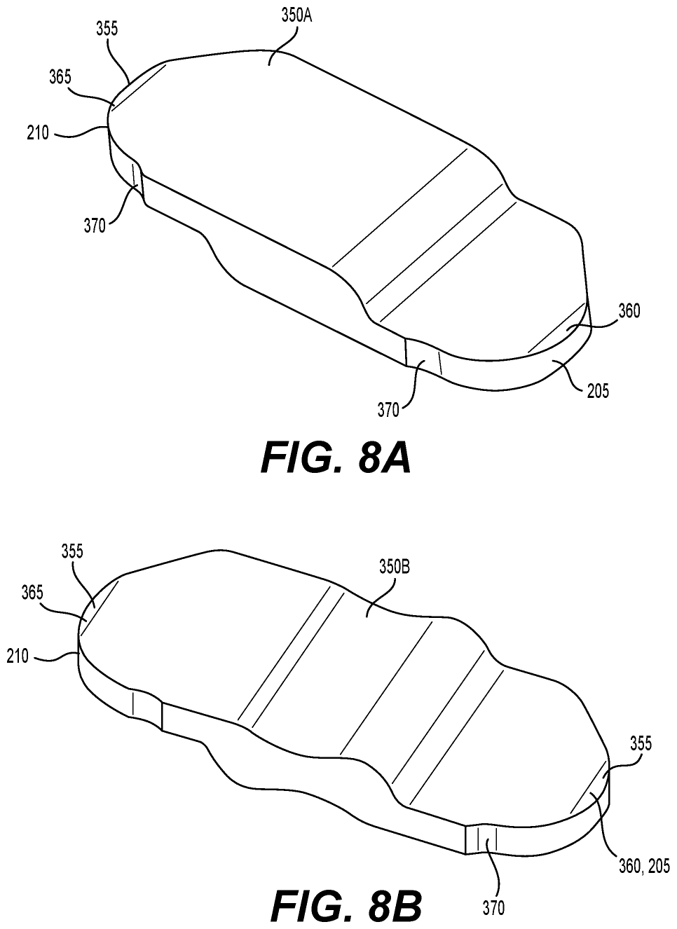

The method 500 may include only steps 505 to 515. In addition, one or more steps of the method 500 may be performed within the same operation. For example, steps 505 to 515 may be performed in the same operation. Alternatively, the method 500 may include one or more additional steps. For example, the method 500 may also include a step of trimming edges 355 of the functional track links 350. In particular, a front edge 360 and a back edge 365 of each functional track link 350 may be trimmed, for example, to form curved edges along a front surface 205 and/or a back surface 210 of each functional track link 350. Also, chamfers 370 may be formed between and/or on surfaces of each functional track link 350. Trimming the track links 350 may be done using a laser or a torch, using a shearing punch that is either hot or cold, or using a drill or a mill. FIGS. 8A and 8B shows track links 350 trimmed in accordance with this step. FIG. 8A shows the trimmed track link 350A, corresponding to the track link shown in FIG. 2, and FIG. 8B shows the trimmed functional track link 350B, corresponding to the track link shown in FIG. 3.

The method 500 may include an additional step of forming a counter bore 230 within an inner surface 195 of the front portion 185, the counter bore 230 aligning with the pin bore 225. The counter bore 230 may be formed using a laser or a torch, using a shearing punch that is hot or cold, or using a drill or a mill. The method 500 may also include chamfering edges of the pin bore 225, the bushing bore 245, and/or the counter bore 230. The track link 110A shown in FIG. 2 is the track link including a drilled and chamfered bushing bore 245, pin bore 225, and counter bore 230, as well as drilled bolt holes 250 and windows 255. And the track link 110B shown in FIG. 3 is the track link including a drilled and chamfered bushing bore 245, pin bore 225, and counter bore 230, as well as drilled bolt holes 250 and windows 255.

The track links, and the related track link assemblies and method of manufacturing track link assemblies, of the present disclosure require relatively fewer manufacturing steps. The track link has a uniform thickness along a width thereof, other than at the holes, and can be formed using rolling, without requiring additional manufacturing steps, such as bending or welding. The uniform thickness along the width of the track link optimizes material use around and between track shoe bolt holes. That is, the track links having the uniform thickness along the width thereof can be formed using relatively less steel, in terms of mass, and therefore are less expensive to manufacture. Also, the roll form manufacturing method allows for creation of the offset between the front portions and the back portions of the track links, which enables articulation of the track links during use in a track link assembly. In addition, a plurality of track links may be formed from one length of rolled material, by cutting the length of rolled material at predetermined widths. That is, the relatively less complex three-dimensional shape of the track links in accordance with the present disclosure can be formed using fewer manufacturing steps and, as a result, the cost and time of manufacture can be reduced.

It will be apparent to those skilled in the art that various modifications and variations can be made to the disclosed track link and related track link assembly and method of manufacture, without departing from the scope of the disclosure. Other embodiments of the track link, track link assembly, and method of manufacture will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

1. A rolled track link comprising:
a central portion;
a front portion, on a front side of the central portion, having a front portion planar upper surface and a pin bore; and
a back portion, on a back side of the central portion, having a back portion planar upper surface that is offset from the front portion planar upper surface by a perpendicular distance along a height of the track link, and having a bushing bore,
wherein, at each point along a length of the track link, a thickness of the track link is uniform along a width of the track link, other than at holes, including the pin bore and the bushing bore.

2. The track link according to claim 1, wherein the track link is formed of rolled steel.

3. The track link according to claim 1, wherein a thickness of the front portion is the same as a thickness of the back portion.

4. The track link according to claim 1, wherein a thickness of the central portion varies.

5. The track link according to claim 1, wherein the central portion includes at least one concave curved surface.

6. The track link according to claim 1, wherein the perpendicular distance between the front portion plane and the back portion plane is about 1.5 mm.

7. The track link according to claim 1, wherein the central portion has at least one bolt hole that is perpendicular to the pin bore in the front portion and the bushing bore in the back portion.

8. The track link according to claim 7, wherein the central portion has at least one window that is perpendicular to and intersects the at least one bolt hole.

9. A track link formed by rolling, the track link consisting of:
a central portion;
a front portion, on a front side of the central portion, having a front portion planar upper surface and a pin bore; and
a back portion, on a back side of the central portion, having a back portion planar upper surface that is offset from the front portion planar upper surface by a perpendicular distance along a height of the track link, and having a bushing bore.

10. The track link assembly according to claim 9, wherein the track link is formed of rolled steel.

11. The track link assembly according to claim 9, wherein a thickness of the front portion is the same as a thickness of the back portion.

12. The track link assembly according to claim 9, wherein a thickness of the central portion varies.

13. The track link assembly according to claim 9, wherein the perpendicular distance between the front portion plane and the back portion plane of each track link is about 1.5 mm.

14. The track link assembly according to claim 9, wherein the central portion includes at least one concave curved surface.

15. The track link assembly according to claim 9, wherein the central portion of each track link has at least one bolt hole that is perpendicular to the pin bore in the front portion and the bushing bore in the back portion.

16. The track link assembly according to claim 15, wherein the central portion of each track link has at least one window that is perpendicular to and intersects the at least one bolt hole.

17. A method of manufacturing one or more track links, the method comprising:
rolling a sheet of a material lengthwise to form a cross-sectional shape having a central portion, a front portion on a front side of the central portion that is defined by a front portion plane, and a back portion on a back side of the central portion that is defined by a back portion plane that is offset from the front portion plane by a perpendicular distance along a height of the sheet of material;
cutting the rolled sheet of material at a predetermined width, into the one or more track links each having a uniform thickness along the width; and
forming a pin bore through the front portion and a bushing bore through the back portion of each track link.

18. The method according to claim 17, consisting of the steps of rolling the sheet of material, cutting the rolled sheet of material, and forming the pin bore and the bushing bore to thereby form the one or more track links.

19. The method according to claim 17, wherein rolling the sheet of material includes forming at least one curved surface on the central portion.

20. The method according to claim 17, further comprising trimming at least a front edge and a back edge of each track link, to form a curved front surface and a curved back surface.
